(19) United States
(12) Patent Application Publication
(10) Pub. No.: US 2007/0134496 A1
(43) Pub. Date: Jun. 14, 2007

(54) Carbon nanotube-dispersed composite material, method for producing same and article same is applied to

(75) Inventors: Kazuaki Katagiri, Hyogo (JP); Atsushi Kakitsuji, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: SUMITOMO PRECISION PRODUCTS CO., LTD., Hyogo (JP); Osaka Prefectural Government, Osaka (JP)

(21) Appl. No.: 10/577,875

(22) PCT Filed: Oct. 29, 2004
(86) PCT No.: PCT/JP04/16495

§ 371 Date: Dec. 6, 2006

(30) Foreign Application Priority Data
Oct. 29, 2003 (JP) 2003-368399
Mar. 2, 2004 (JP) 2004-057086

(51) Int. Cl. B32B 9/00; C09C 1/56

(52) U.S. Cl. 428/408; 423/460; 423/414

(57) ABSTRACT

The present invention has an object of providing a carbon nanotube dispersed composite material utilizing as much as possible excellent electric conductivity, heat conductive property and strength property owned by a carbon nanotube itself and taking advantage of characteristics of ceramics having corrosion resistance and heat resistance such as zirconia and the like, and a method of producing the same; and long-chain carbon nanotubes (including those obtained by previous discharge plasma treatment of only carbon nanotubes) are kneaded and dispersed by a ball mill together with calcinable ceramics and metal powder, and this is integrated by discharge plasma sintering, and carbon nanotubes can be thus dispersed in the form of network in the sintered body, and the electric conductivity property, heat conductive property and strength property of the carbon nanotube can be effectively used together with the properties of the ceramics and metal powder base material.

### TECHNICAL FIELD

The present invention relates to a composite material endowed with electric conductivity, heat conductivity and excellent strength property utilizing original features of ceramics having corrosion resistance and heat resistance such as silicon carbide and the like, and relates to a carbon nanotube dispersed composite material in which long-chain carbon nanotubes are dispersed in the form of network in a sintered body of ceramics or metal powder, a method of producing the same, and an applied substance thereof.

### BACKGROUND ART

At the present day, there are suggested composite materials endowed with various functions using a carbon nanotube. For example, there is a suggestion (Japanese Patent Application Laid-Open (JP-A) No. 2003-12939) on processing and molding of a carbon-containing resin composition prepared by dispersing carbon nanotubes having an average diameter of 1 to 45 nm and an average aspect ratio of 5 or more in a resin such as an epoxy resin, unsaturated polyester resin or the like kneaded with a filler such as carbon fiber, metal-coated carbon fiber, carbon powder, glass fiber and the like, for intending a molded body having excellent strength and moldability, and conductivity together.

For the purpose of improving heat conductivity and tensile strength of an aluminum alloy, there is suggested an aluminum alloy material obtained by combining at least one of Si, Mg and Mn as components to be contained in the aluminum alloy material with carbon nanofiber, to allow the carbon nanofiber to be contained in an aluminum mother material. This is provided as an extrusion mold material of an aluminum alloy material obtained by mixing carbon nanofiber in an amount of 0.1 to 5 vol % in a melted aluminum alloy material, kneading the mixture, then, making billets from the mixture, and extrusion-molding the billets (JP-A No. 2002-363716).

Further, a resin molded body having excellent moldability and conductivity simultaneously is suggested (JP-A No. 2003-34751) obtained by compounding a metal compound (boride: TiB₂, WB, MoB, CrB, AlB₂, MgB, carbide: WC, nitride: TiN and the like) and carbon nanotubes in suitable amounts in a thermoplastic resin excellent in flowability such as PPS, LCP and the like, for the purpose of obtaining a high conductive material excellent in moldability which can be applied to a separator of a fuel cell, and the like.

Furthermore, there is suggested to compound carbon nanotubes in a matrix of an organic polymer such as a thermoplastic resin, thermosetting resin, rubber, thermoplastic elastomer and the like and orient the carbon nanotubes in magnetic field, to give a composite molded body in which the carbon nanotubes are arranged along a certain direction to form composite state, for improving electric, thermal and mechanical properties, and there is suggested to perform various treatments such as degreasing treatment, washing treatment and the like previously on the surface of a carbon nanotube, for improving wettability and adhesiveness between the carbon nanotube and the matrix material (JP-A No. 2002-273741).

There is suggested a production method in which a metal alloy of a nanotube-wettable element such as indium, bismuth, lead or the like, a powder of a conductive material such as a metal powder which is relatively soft and ductile such as in the case of Ag, Au or Sn, and carbon nanotubes are press-molded, cut and polished, then, projecting nanotubes are formed on the surface, this surface is etched to form nanotube ends, then, the metal surface is re-dissolved, to align the projecting nanotubes, giving a field emitter containing carbon nanotubes (JP-A No. 2000-223004).

For the purpose of obtaining a ceramics composite nanostructure for multilaterally realizing various functions to give optimum functions, there is a suggestion in which, for example, a production method in which different metal elements are bonded via oxygen is selected so that the structure is constituted of oxides of a plurality of poly-valent metal elements selected for the purpose of obtaining some functions, further, a columnar body having a maximum diameter on the minor axis cross-section of 500 nm or less is produced by known various methods (JP-A No. 2003-238120).

Regarding the above-mentioned carbon nanotubes to be dispersed in a resin or aluminum alloy, those having a length as short as possible are used to increase dispersibility thereof, in view of produceability of the resulting composite material and required moldability, and there is no intention to effectively utilize excellent electric conductivity and heat conductivity owned by a carbon nanotube itself.

In the above-mentioned invention for utilizing a carbon nanotube itself, specialization to a concrete and specific use such as, for example, a field emitter is possible, however, application to other uses is not easy, while in the method of producing a ceramics composite nanostructure composed of a specific columnar body by selecting an oxide of a poly-valent metal element for intending a certain function, considerable process and tries and errors for setting the object, selecting the element and establishing the production method are inevitable.

### DISCLOSURE OF THE INVENTION

The present invention has an object of providing a composite material purely utilizing characteristics of ceramics such as silicon carbide, alumina and the like having corrosion resistance and heat resistance though having an insulation property and metals having versatility, ductility and the like, and endowed with electric conductivity and heat conductivity, and has an object of providing a carbon nanotube dispersed composite material utilizing as much as possible excellent electric conductivity and heat conductivity and strength property owned by the original long-chain or network structure of a carbon nanotube itself together with properties of a ceramics or metal powder base material, and a method of producing the same.

The present inventors have variously investigated a constitution capable of effectively using electric conductivity, heat conductivity and strength property of a carbon nanotube, in a composite material containing carbon nanotubes dispersed in a base material developed based on commission of development by Independent Administrative Agency, Japan Science and Technology Agency and resultantly found that if long-chain carbon nanotubes (including those obtained by previously treating only carbon nanotubes by discharge plasma) are kneaded and dispersed together with calcinable ceramics and metal powder by a ball mill, and this is integrated by sintering by discharge plasma, then, carbon nanotubes can be dispersed in the form of network in the sintered body, and the above-mentioned object can be attained, leading to completion of the present invention.

That is, the present invention is a carbon nanotube dispersed composite material wherein long-chain carbon nanotubes are dispersed and integrated in the form of network into a discharge plasma sintered body composed of an insulable ceramics (but excluding alumina) or metal (but excluding aluminum or its alloy) powder or a mixed powder of ceramics and metal, and having electric conductivity, heat conductivity and high strength.

Further, the present invention is a method of producing a carbon nanotube dispersed composite material comprising a process of kneading and dispersing a ceramics powder or metal powder or a mixed powder of ceramics and metal, and long-chain carbon nanotubes (including those obtained by previous treatment of only carbon nanotubes by discharge plasma) by a ball mill, or a process of wet-dispersing the above-mentioned powder and carbon nanotubes further using a dispersing agent, and a process of sintering the dried knead-dispersed material by discharge plasma.

The composite material according to the present invention uses as a substrate a sintered body of a ceramics powder such as alumina, zirconia and the like excellent in corrosion resistance and heat resistance or a metal powder such as pure aluminum, aluminum alloy, titanium and the like excellent in corrosion resistance and heat releasability. Therefore, this material itself originally has corrosion resistance and excellent durability under high temperature environments. Additionally, since long-chain carbon nanotubes are uniformly dispersed, reinforcement of required properties, synergistic effects thereof or novel functions can be manifested together with excellent electric conductivity, heat conductivity and strength owned by a carbon nanotube itself.

The composite material according to the present invention can be produced by a relatively simple production method of kneading and dispersing a ceramics powder or metal powder or a mixed powder of ceramics and metal and long-chain carbon nanotubes by a ball mill, and subjecting the dispersed material to discharge plasma sintering, and for example, can be applied as electrodes and exothermic bodies under corrosion and high temperature environments, wiring materials, and heat exchangers and heat sink materials having improved heat conductivity, brake parts, or electrodes and separators of fuel cells, and the like.

### BRIEF DESCRIPTION OF THE DRAWINGS

FIG. 1 is a graph showing a relation between plasma sintering temperature and electric conductivity.

FIG. 2 is a graph showing a relation between sintering pressing force and electric conductivity.

FIG. 3A is a schematic view of an electron micrograph of a forcible fracture surface of a carbon nanotube dispersed composite material using titanium as a matrix according to the present invention, and FIG. 3B is a schematic view of an enlarged electron micrograph of the forcible fracture surface.

FIG. 4 is a schematic view of an electron micrograph of a carbon nanotube in the form of cocoon according to the present invention.

FIG. 5 is a schematic view of an electron micrograph of a carbon nanotube dispersed composite material using alumina as a matrix according to the present invention.

FIG. 6A is a schematic view of an electron micrograph of a forcible fracture surface of a carbon nanotube dispersed composite material using copper as a matrix according to the present invention, and FIG. 6B is a schematic view of an enlarged electron micrograph of the forcible fracture surface.

FIG. 7A is a schematic view of an electron micrograph of a forcible fracture surface of a carbon nanotube dispersed composite material using zirconia as a matrix according to the present invention, and FIG. 7B is a schematic view of an enlarged electron micrograph of the forcible fracture surface.

### BEST MODES FOR CARRYING OUT THE INVENTION

In the present invention, ceramics having known high function and various functions such as alumina, zirconia, aluminum nitride, silicon carbide, silicon nitride and the like can be adopted as the ceramics powder to be used. For example, known functional ceramics manifesting necessary functions such as, for example, corrosion resistance, heat resistance and the like may advantageously be adopted.

The particle size of the ceramics powder can be determined considering sinterability capable of forming a necessary sintered body and considering disassembling ability in knead-dispersion with carbon nanotubes, and preferably about 10 μm or less, and for example, several large and small particle sizes may be used, and also a constitution including a plurality of different powders having mutually different particle sizes may be adopted, and in the case of a single powder, the particle size is preferably 5 μm or less, further preferably 1 μm or less. As the powder, powders of various shapes such as fiber, amorphous and the like can also be appropriately utilized in addition to sphere.

In the present invention, pure aluminum, known aluminum alloy, titanium, titanium alloy, copper, copper alloy, stainless steel and the like can be adopted as the metal powder to be used. For example, known functional metals manifesting necessary functions such as corrosion resistance, heat conductivity, heat resistance and the like may be advantageously adopted.

As the metal powder, those having sinterability capable of forming a necessary sintered body and disassembling ability in knead-dispersion with carbon nanotubes and having a particle size of about 100 μm or less, further 50 μm or less, are preferable, and several large and small particle sizes may be used, and also a constitution including a plurality of different powders having mutually different particle sizes may be adopted, and in the case of a single powder, the particle size is preferably 10 μm or less. As the powder, powders of various shapes such as fiber, amorphous, tree and the like can also be appropriately utilized in addition to sphere. The particle size of aluminum or the like is preferably 50 μm to 150 μm.

In the present invention, the long-chain carbon nanotube to be used means literally a long chain formed by connecting carbon nanotubes, and a bulk formed by entangling them or a bulk in the form of cocoon, or those in the form of cocoon or network obtained by discharge plasma treatment of only carbon nanotubes, are used. As the structure of a carbon nanotube itself, any of single layer and multi-layer can be used.

In the composite material according to the present invention, the carbon nanotube content is not particularly restricted providing a sintered body having necessary shape and strength can be formed, and can be, for example, 90 wt % or less in terms of weight ratio by appropriately selecting the kind and particle size of a ceramics powder or metal powder.

Particularly, in the case for the purpose of homogeneity of a composite material, it is necessary that the carbon nanotube content is 3 wt % or less, if necessary, lowered to about 0.05 wt %, and a knead-dispersion method and kneading conditions such as selection of particle size and the like are required to be devised.

The method of producing a carbon nanotube dispersed composite material according to the present invention includes:

(P) a process of treating a long-chain carbon nanotube by discharge plasma;

(1) a process of kneading and dispersing a ceramics powder or metal powder or a mixed powder of ceramics and metal, and long-chain carbon nanotubes by a ball mill;

(2) a process of wet-dispersing the above-mentioned powder and carbon nanotubes further using a dispersing agent; and

(3) a process of sintering the dried knead-dispersed material by discharge plasma, and combinations of processes (1)(3), (P)(1)(3), (1)(2)(3) and (P)(1)(2)(3) are included. Any of the processes (1) and (2) may be used first, and a plurality of these processes may be combined appropriately.

In the knead-dispersing process, it is important to flake and disassemble the above-mentioned long-chain carbon nanotube in a ceramics powder or metal powder or a mixed powder of ceramics and metal. For knead-dispersion, known various mills, crushers and shakers for carrying out grinding, crushing and disassembly can be appropriately adopted, and as the mechanism thereof, known mechanisms can be appropriately used such as rotation impact mode, rotation sharing mode, rotation impact shearing mode, medium stirring mode, stirring mode, stirring mode without stirring blade, airflow grinding mode, and the like.

In particularly, the ball mill can take any structure providing it performs grinding or disassembly using a medium such as a ball and the like, like known horizontal, planet type, stirring type mills and the like. The material and particle size of the medium can also be appropriately selected. In the case of previous treatment of only carbon nanotubes by discharge plasma, it is necessary to set conditions for improving disassembling ability particularly by selecting powder particle size and ball particle size.

In the present invention, a known nonionic dispersing agent, cationic or anionic dispersing agent is added and can be dispersed using an ultrasonic mode dispersing apparatus, the above-mentioned various mills typically including a ball mill, crusher or shaker, in the process of wet-dispersing, and the above-mentioned dry mode dispersing time can be shortened and efficiency thereof can be enhanced. In the method of drying a slurry after wet dispersion, known heat sources and spin method can be appropriately adopted.

In the present invention, the process of sintering (treating) by discharge plasma is a method in which a dried knead-dispersed material is filled between a carbon die and a punch, and direct current pulse current is allowed to flow while pressing by upper and lower punches, and Joule heat is thus generated in the die, punches and treated material, to sinter the knead-dispersed material, and by flowing pulse current, discharge plasma is generated between powders or between carbon nanotubes, and impurities on the surface of powders and carbon nanotubes disappear to cause activation, and the like, namely, by such actions, sintering progresses smoothly.

The process of further treatment by discharge plasma of the knead-dispersed material obtained in dry mode or wet mode or in both the modes is carried out before the discharge plasma sintering process, and actions and effects are generated such as further progress of disassembly of the knead-dispersed material, action of stretching a carbon nanotube, surface activation, diffusion of a powder, and the like, and heat conductivity and electric conductivity imparted to a sintered body are improved, together with the subsequent smooth progress of discharge plasma sintering.

The condition of discharge plasma treatment on the knead-dispersed material is not particularly restricted, and when taking sintering temperature of a treated material into consideration, for example, temperature, time and pressure can be appropriately selected in a range of 200° C. to 1400° C., in a range of about 1 to 15 minutes, and in a range of 0 to 10 Mpa, respectively.

In the present invention, the discharge plasma sintering is preferably carried out at lower temperature than usual sintering temperature of a ceramics powder or metal powder to be used. Particularly high pressure is not required, and it is preferable to set conditions so as to give relatively low pressure and low temperature in sintering. In the above-mentioned process of sintering the knead-dispersed material by discharge plasma, a two-step process is also preferable in which, first, plasma discharge is carried out at low temperature under low pressure, then, discharge plasma sintering is conducted at low temperature under high pressure. It is also possible to utilize deposition and hardening after sintering, and phase change by various heat treatments. Levels of pressure and temperature are relative between the above-mentioned two steps, and it is advantageous that a difference of the level is set between both the steps.

The composite material according to the present invention can be produced by the above-mentioned relatively simple production method, and can be applied as electrodes and exothermic bodies under corrosion and high temperature environments, wiring materials, heat exchanges and heat sink materials having improved heat conductivity or brake parts, and particularly, as shown in an example, it is possible to obtain a heat conductivity of 800 W/mK or more, and these materials can be, for example, calcined easily into desired shape by a discharge plasma sintering apparatus after previous molding, and optimal for application of a heat exchanger.

### EXAMPLES

### Example 1

An alumina powder having an average particle size of 0.6 μm and long-chain carbon nanotubes were dispersed by a ball mill using an alumina bowl and balls. First, 5 wt % of carbon nanotubes were compounded, and an alumina powder previously sufficiently dispersed was compounded, and these powders were kneaded and dispersed for 96 hours under dry condition.

Further, a nonionic surfactant (Triton X-100, 1 wt %) was added as a dispersing agent, and the mixture was wet-dispersed for 2 hours or more under ultrasonic wave. The resulting slurry was filtrated and dried.

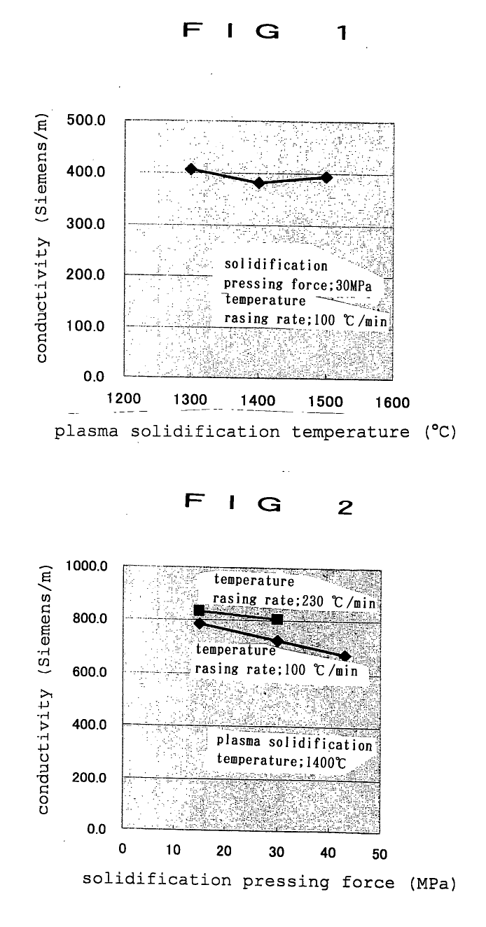

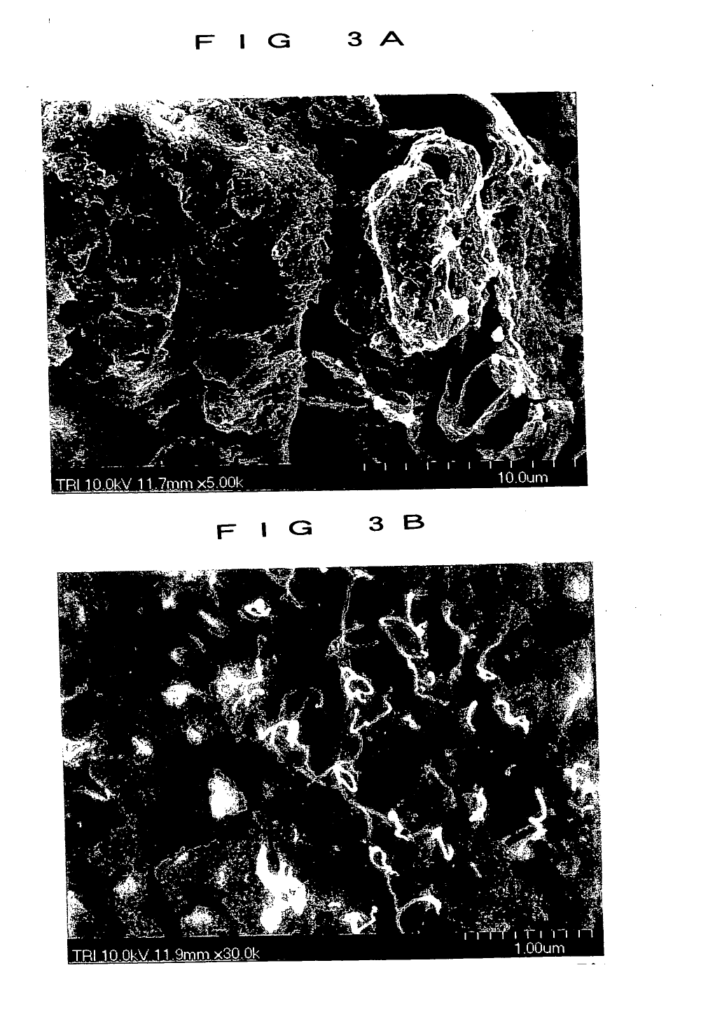

The dried knead-dispersed material was filled in a die of a discharge plasma sintering apparatus, and solidified by plasma at 1300° C. to 1500° C. for 5 minutes. In this procedure, the temperature raising rate was 100° C./min or 230° C./min and a pressure of 15 to 40 MPa was loaded continuously. The electric conductivity of the resulting composite material was measured to obtain results shown in FIGS. 1 and 2.

### Example 2-1

A pure titanium powder containing a pure titanium powder having an average (peak) particle size of 10 μm or less and a pure titanium powder having an average particle size of 30 μm mixed at various proportions, and 10 wt % of long-chain carbon nanotubes were kneaded and dispersed by a ball mill using a titanium bowl and balls under dry condition for 100 hours or more.

The knead-dispersed material was filled in a die of a discharge plasma sintering apparatus, and sintered by discharge plasma at 1400° C. for 5 minutes. In this procedure, the temperature raising rate was 250° C./min and a pressure of 10 MPa was loaded continuously. The electric conductivity of the resulting composite material was measured to obtain 750 to 1000 Siemens/m.

### Example 2-2

A pure titanium powder having an average particle size of 10 μm to 20 μm and 0.1 wt % to 0.25 wt % of long-chain carbon nanotubes (CNT) were kneaded and dispersed by a planet mill using a titanium vessel under dry condition without using dispersion media, in combination of various time units of 2 hours or less and revolution number of the vessel.

The knead-dispersed material was filled in a die of a discharge plasma sintering apparatus, and sintered by discharge plasma at 900° C. for 10 minutes. In this procedure, the temperature raising rate was 100° C./min and a pressure of 60 MPa was loaded continuously.

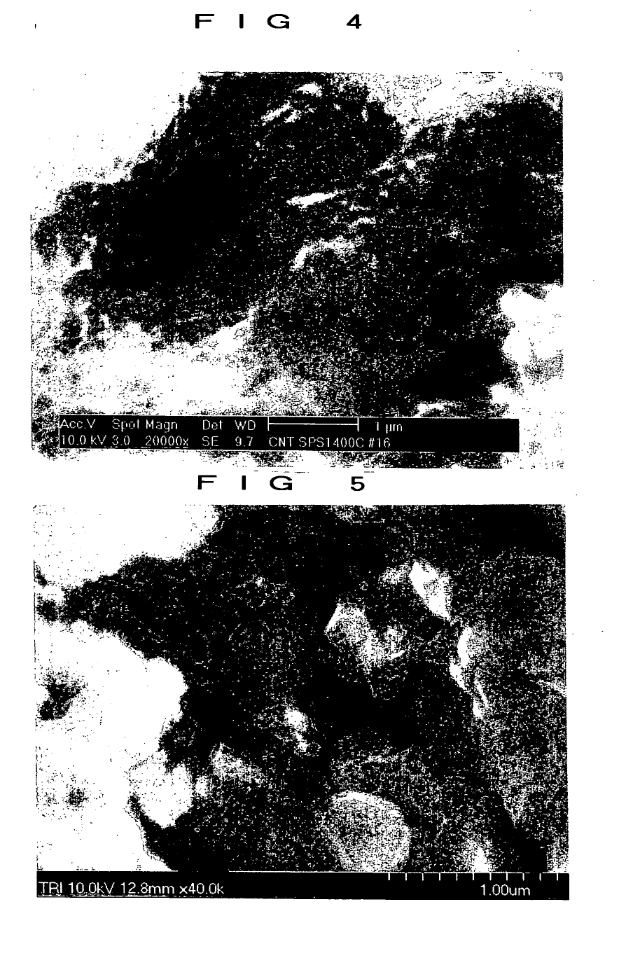

An electron micrograph of a forcible fracture surface of the resulting composite material (CNT 0.25 wt % addition) is shown in FIG. 3. An electron micrograph of a carbon nanotube in the form of network when FIG. 3A in a scale of the order of 10 μm is enlarged to a scale of the order of 1.0 μm is shown in FIG. 3B.

The heat conductivity of the resulting composite material was measured to find a value of 18.4 W/mK. The heat conductivity of a solidified body obtained by sintering only a pure titanium powder by discharge plasma under the above-mentioned condition was 13.8 W/mK, teaching that the heat conductivity of the composite material according to the present invention is increased by about 30%.

### Example 2-3

In kneading and disassembling of a pure titanium powder having an average particle size of 10 μm to 20 μm and 0.05 wt % to 0.5 wt % of long-chain carbon nanotubes, only carbon nanotubes were previously filled in a die of a discharge plasma sintering apparatus, and some were treated by discharge plasma at 575° C. for 5 minutes and some were not subjected to the same treatment, and both were kneaded and dispersed by a planet mill using a titanium vessel under dry condition without using dispersion media, in combination of various time units of 60 minutes or less and revolution number of the vessel.

The knead-dispersed material was filled in a die of a discharge plasma sintering apparatus, and sintered by discharge plasma at 900° C. for 10 minutes. In this procedure, the temperature raising rate was 100° C./min and a pressure of 60 MPa was loaded continuously.

The heat conductivity of the resulting composite material (CNT 0.25 wt % addition) was measured to find a value of 17.2 W/mK in the case of previous discharge plasma treatment of only carbon nanotubes and a value of 11 W/mK in the case of no discharge plasma treatment. It is believed from the above-mentioned results that there is an optimum range between the particle size of a pure titanium powder, amount of carbon nanotubes and disassembling condition, and it is understood that, even out of the optimum range, discharge plasma treatment before disassembling contributes significantly to improvement in heat conductivity.

### Example 3-1

Only carbon nanotubes were previously filled in a die of a discharge plasma sintering apparatus, and treated by discharge plasma at 1400° C. for 5 minutes. An electron micrograph of the resulting carbon nanotube in the form of cocoon is shown in FIG. 4.

An alumina powder having an average particle size of 0.5 μm and the above-mentioned carbon nanotubes were dispersed by a ball mill using an alumina bowl and balls. First, 5 wt % of carbon nanotubes were compounded, then, a sufficiently dispersed alumina powder was compounded, and the mixture was kneaded and dispersed under dry condition for 96 hours. Further, the same ultrasonic wave dry dispersion as in Example 1 was carried out. The resulting slurry was filtrated an dried.

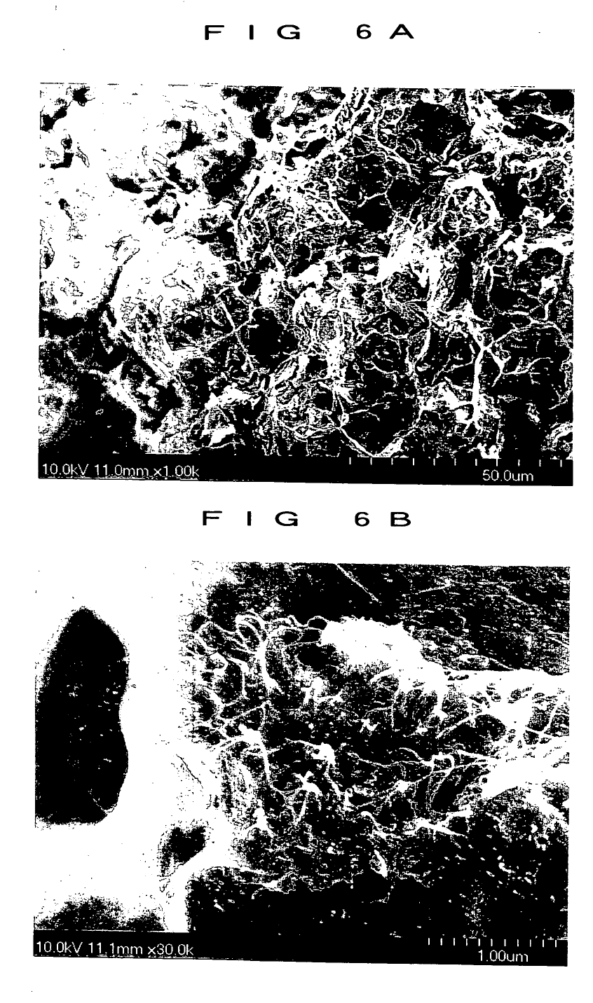

The dried knead-dispersed material was filled in a die of a discharge plasma sintering apparatus, and solidified by plasma at 1400° C. for 5 minutes. In this procedure, the temperature raising rate was 200° C./min and a pressure first of 15 MPa, then, of 30 MPa was loaded. The electric conductivity of the resulting composite material was in the same range as in Example 1. An electron micrograph of the resulting composite material is shown in FIG. 5.

### Example 3-2

In kneading and disassembling of an alumina powder having an average particle size of 0.6 μm and 0.5 wt % of long-chain carbon nanotubes, only carbon nanotubes were previously filled in a die of a discharge plasma sintering apparatus, and some were treated by discharge plasma at 575° C. for 5 minutes and some were not subjected to the same treatment, and both were kneaded and dispersed by a planet mill using an alumina vessel under dry condition without using dispersion media, in combination of various time units of 2 hours or less and revolution number of the vessel.

The knead-dispersed material was filled in a die of a discharge plasma sintering apparatus, and sintered by discharge plasma at 1400° C. for 5 minutes. In this procedure, the temperature raising rate was 100° C./min and a pressure first of 20 MPa, then, of 60 MPa was loaded continuously.

The heat conductivity of the resulting composite material was measured to find a value of 50 W/mK in the case of previous discharge plasma treatment of only carbon nanotubes and a value of 30 W/mK in the case of no discharge plasma treatment. The heat conductivity of a solidified body obtained by sintering only a pure alumina powder by discharge plasma under the above-mentioned condition was 25 W/mK.

### Example 4-1

An oxygen free copper powder (Mitsui Mining & Smelting Co., Ltd., atomized powder) having an average particle size of 50 μm or a copper alloy powder (Cu90-Zn10, Mitsui Mining & Smelting Co., Ltd., atomized powder) having an average particle size of 50 μm, and 10 wt % of long-chain carbon nanotubes were dispersed by a ball mill using a stainless steel bowl and ferrochromium balls. First, carbon nanotubes were compounded, then, a sufficiently dispersed oxygen free copper powder or copper alloy powder was compounded, and the mixture was kneaded and dispersed under wet condition for 10 hours or more using a nonionic surfactant (Triton X-100, 1 wt %) as a dispersing medium.

The dried knead-dispersed material was filled in a die of a discharge plasma sintering apparatus, and sintered by discharge plasma at 700° C. to 900° C. for 5 minutes. In this procedure, the temperature raising rate was 80° C./min and a pressure of 10 MPa was loaded continuously. The electric conductivity of the resulting two composite materials was measured to find a value in a range of 500 to 800 W/mK in each case.

### Example 4-2

An oxygen free copper powder (Mitsui Mining & Smelting Co., Ltd., atomized powder) having an average particle size of 20 μm to 30 μm and 0.5 wt % of long-chain carbon nanotubes were kneaded and dispersed by a planet mill using a stainless steel vessel under dry condition without using dispersion media, in combination of various time units of 2 hours or less and revolution number of the vessel.

Then, the knead-dispersed material was filled in a die of a discharge plasma sintering apparatus, and treated by discharge plasma at 575° C. for 5 minutes.

Then, the knead-dispersed material was sintered by discharge plasma at 800° C. for 15 minutes in a discharge plasma sintering apparatus. In this procedure, the temperature raising rate was 100° C./min and a pressure of 60 MPa was loaded continuously.

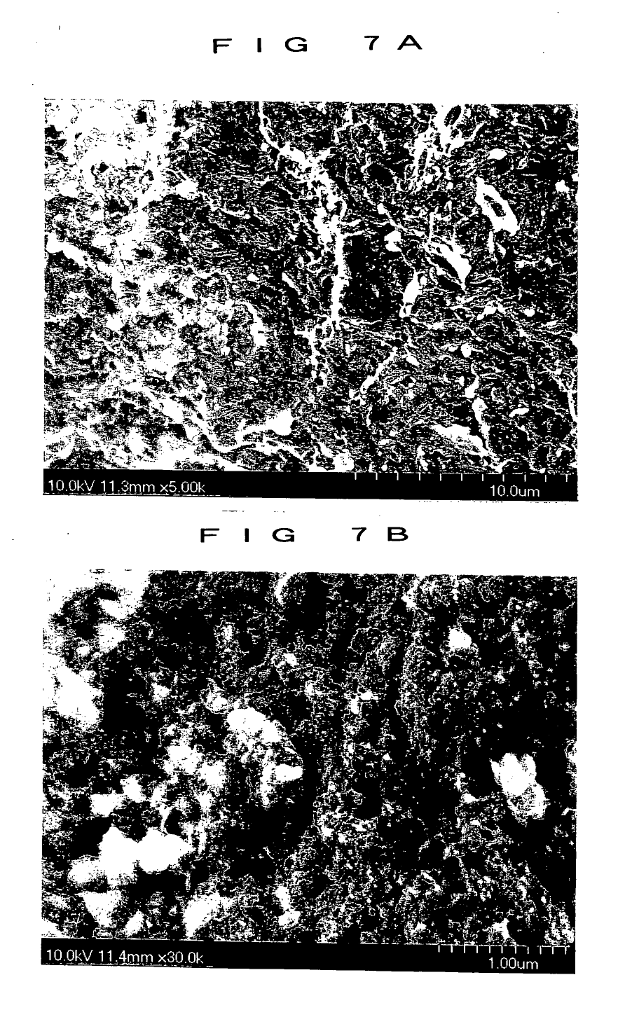

An electron micrograph of a forcible fracture surface of the resulting composite material is shown in FIG. 6A. An electron micrograph of a carbon nanotube in the form of network when FIG. 6A in a scale of the order of 50 μm is enlarged to a scale of the order of 1.0 μm is shown in FIG. 6B.

The electric conductivity of the resulting composite material was measured to find that an electric resistance of a solidified body obtained by discharge plasma sintering of only an oxygen free copper powder under the above-mentioned condition was about 5×10⁻³ Ωm, and an electric resistance of the composite material according to the present invention of about 56% (conductivity increased to about 1.7-fold). The unit of electric resistance is in a relation of Siemens/m=(Ωm)⁻¹.

### Example 5-1

A zirconia powder having an average particle size of 0.6 μm (manufactured by Sumitomo Osaka Cement Co., Ltd.) and 5 wt % of long-chain carbon nanotubes were dispersed by a ball mill using a zirconia bowl and balls. First, carbon nanotubes were compounded, and a zirconia powder previously sufficiently dispersed was compounded, and these powders were kneaded and dispersed for 100 hours or more under dry condition.

The knead-dispersed material was filled in a die of a discharge plasma sintering apparatus, and solidified by plasma at 1200° C. to 1400° C. for 5 minutes. In this procedure, the temperature raising rate was 100° C./min or 230° C./min and a pressure of 15 to 40 MPa was loaded continuously. The electric conductivity of the resulting composite material was measured to find a value of 500 to 600 Siemens/m.

### Example 5-2

A zirconia powder having an average particle size of 0.5 μm (manufactured by Sumitomo Osaka Cement Co., Ltd.) and 1 wt % of long-chain carbon nanotubes were dispersed by a planet high speed mill using a zirconia vessel. First, carbon nanotubes were compounded, and a zirconia powder previously sufficiently dispersed was compounded, and these powders were kneaded and dispersed under dry condition without using dispersion media, in combination of various time units of 2 hours or less and revolution number of the vessel.

The knead-dispersed material was filled in a die of a discharge plasma sintering apparatus, and solidified by plasma at 1200° C. for 5 minutes. In this procedure, the temperature raising rate was 100° C./min and a pressure of 50 MPa was loaded continuously.

The electric resistance of the resulting composite material was measured to find that the electric resistance of the composite material according to the present invention was about 72% (conductivity increased to about 1.4-fold) based on the electric resistance of a solidified body obtained by sintering only a zirconia powder by discharge plasma under the above-mentioned condition.

### Example 5-3

A zirconia powder having an average particle size of 0.5 μm (manufactured by Sumitomo Osaka Cement Co., Ltd.) and 0.05 wt % to 0.5 wt % of long-chain carbon nanotubes previously filled in a die of a discharge plasma sintering apparatus and treated by discharge plasma at 575° C. for 5 minutes were kneaded and dispersed by a planet high speed mill using a zirconia vessel under dry condition without using dispersion media, in combination of various time units of 60 minutes or less and revolution number of the vessel.

The knead-dispersed material was filled in a die of a discharge plasma sintering apparatus, and treated by discharge plasma at 575° C. for 5 minutes. Then, the knead-dispersed material was sintered by discharge plasma at 1350° C. for 5 minutes in a discharge plasma sintering apparatus. In this procedure, the temperature raising rate was 100° C./min and a pressure of 60 MPa was loaded continuously.

An electron micrograph of a forcible fracture surface of the resulting composite material is shown in FIG. 9. An electron micrograph of a carbon nanotube in the form of network when FIG. 7A in a scale of the order of 10 μm is enlarged to a scale of the order of 1.0 μm is shown in FIG. 7B.

The heat conductivity of the resulting composite material (CNT 0.5 wt % addition) was measured to find a value of 4.7 W/mK. The heat conductivity of a solidified body obtained by sintering only a zirconia powder by discharge plasma under the above-mentioned condition was 2.9 W/mK, teaching that the heat conductivity of the composite material according to the present invention is increased by about 60%.

### Example 6

An aluminum nitride powder having an average particle size of 0.5 μm (manufactured by Tokuyama Corp.) and 5 wt % of long-chain carbon nanotubes were dispersed by a ball mill using an alumina bowl and balls. First, carbon nanotubes were compounded, and an aluminum nitride powder previously sufficiently dispersed was compounded, and these powders were kneaded and dispersed for 100 hours or more under dry condition.

The knead-dispersed material was filled in a die of a discharge plasma sintering apparatus, and solidified by plasma at 1600° C. to 1900° C. for 5 minutes. In this procedure, the temperature raising rate was 100° C./min or 230° C./min and a pressure of 15 to 40 MPa was loaded continuously. The electric conductivity and the heat conductivity of the resulting composite material were measured to find a value of 500 to 600 Siemens/m and a value of 500 to 800 W/mk, respectively.

### Example 7-1

A silicon carbide powder having an average particle size of 0.3 μm and 5 wt % of long-chain carbon nanotubes were dispersed by a ball mill using an alumina bowl and balls. First, carbon nanotubes were compounded, and a silicon carbide powder previously sufficiently dispersed was compounded, and these powders were kneaded and dispersed for 100 hours or more under dry condition.

The knead-dispersed material was filled in a die of a discharge plasma sintering apparatus, and solidified by plasma at 1800° C. to 2000° C. for 5 minutes. In this procedure, the temperature raising rate was 100° C./min or 230° C./min and a pressure of 15 to 40 MPa was loaded continuously. The electric conductivity of the resulting composite material were measured to find a value of 500 to 600 Siemens/m.

### Example 7-2

A silicon carbide powder having an average particle size of 0.3 μm and 2 wt % of long-chain carbon nanotubes were dispersed by a planet high speed mill using an alumina vessel. First, carbon nanotubes were compounded, and a silicon carbide powder previously sufficiently dispersed was compounded, and these powders were kneaded and dispersed under dry condition without using dispersion media, in combination of various time units of 2 hours or less and revolution number of the vessel.

The knead-dispersed material was filled in a die of a discharge plasma sintering apparatus, and solidified by plasma at 1850° C. for 5 minutes. In this procedure, the temperature raising rate was 100° C./min and a pressure of 60 MPa was loaded continuously.

The electric resistance of the resulting composite material was measured to find that the electric resistance of the composite material according to the present invention was about 93% (conductivity increased to about 1.08-fold) based on the electric resistance of a solidified body obtained by sintering only a silicon carbide powder by discharge plasma under the above-mentioned condition.

### Example 7-3

A silicon carbide powder having an average particle size of 0.3 μm and 0.25 wt % of long-chain carbon nanotubes were dispersed by a planet high speed mill using an alumina vessel. First, carbon nanotubes were compounded, and a silicon carbide powder previously sufficiently dispersed was compounded, and these powders were kneaded and dispersed under dry condition without using dispersion media, in combination of various time units of 2 hours or less and revolution number of the vessel.

The knead-dispersed material was filled in a die of a discharge plasma sintering apparatus, and solidified by plasma at 1850° C. for 5 minutes. In this procedure, the temperature raising rate was 100° C./min and a pressure of 100 MPa was loaded continuously.

The heat conductivity of the resulting composite material was measured to find a value of 92.3 W/mK. The heat conductivity of a solidified body obtained by sintering only a silicon carbide powder by discharge plasma under the above-mentioned condition was 24.3 W/mK, teaching that the heat conductivity of the composite material according to the present invention is increased by about 279%.

### Example 8

A silicon carbide powder having an average particle size of 0.5 μm (manufactured by Ube Industries, Ltd.) and 5 wt % of long-chain carbon nanotubes were dispersed by a ball mill using an alumina bowl and balls. First, carbon nanotubes were compounded, and a silicon nitride powder previously sufficiently dispersed was compounded, and these powders were kneaded and dispersed under dry condition for 100 hours or more.

The dried knead-dispersed material was filled in a die of a discharge plasma sintering apparatus, and solidified by plasma at 1500° C. to 1600° C. for 5 minutes. In this procedure, the temperature raising rate was 100° C./min or 230° C./min and a pressure of 15 to 40 MPa was loaded continuously. The electric conductivity of the resulting composite material was measured to find a value of 400 to 500 Siemens/m.

### Example 9

A mixed powder (90 wt %) of a pure aluminum powder having an average particle size of 100 μm and an alumina powder having an average particle size of 0.6 μm, and long-chain carbon nanotubes (10 wt %) were dispersed by a ball mill using an alumina bowl and balls. First, carbon nanotubes were compounded, a mixed powder of a pure aluminum powder (95 wt %) and an alumina powder (5 wt %) previously sufficiently dispersed was compounded, and these powders were kneaded and dispersed under dry condition for 100 hours or more. Further, a nonionic surfactant (Triton X-100, 1 wt %) as a dispersing medium was added, and wet-dispersed under ultrasonic wave for 2 hours or more. The resulting slurry was filtrated and dried.

The knead-dispersed material was filled in a die of a discharge plasma sintering apparatus, and solidified by plasma at 500° C. to 600° C. for 5 minutes. In this procedure, the temperature raising rate was 100° C./min or 230° C./min and a pressure of 15 to 40 MPa was loaded continuously. The electric conductivity of the resulting composite material was measured to find a value of 250 to 400 W/mK.

### Example 10

A mixed powder (90 wt %) of a titanium powder having an average particle size of 50 μm and a zirconia powder having an average particle size of 0.6 μm, and 10 wt % of long-chain carbon nanotubes were kneaded and dispersed by a ball mill using a stainless steel bowl and ferrochromium balls. First, carbon nanotubes were compounded, and a mixed powder of a titanium powder (90 wt %) previously dispersed sufficiently and a zirconia powder (10 wt %) was compounded, and these powders were kneaded and dispersed under dry condition for 100 hours or more.

The knead-dispersed material was filled in a die of a discharge plasma sintering apparatus, and sintered by discharge plasma at 1400° C. for 5 minutes. In this procedure, the temperature raising rate was 250° C./min and a pressure of 10 MPa was loaded continuously. The electric conductivity of the resulting composite material was measured to find a value of 750 to 1000 W/mK.

### Example 11

A mixed powder of an oxygen free copper powder (Mitsui Mining & Smelting Co., Ltd., atomized powder) having an average particle size of 50 μm and an alumina powder having an average particle size of 0/6 μm, and 10 wt % of long-chain carbon nanotubes were dispersed by a ball mill using a stainless steel bowl and ferrochromium balls. First, carbon nanotubes were compounded, then, a mixed powder of oxygen free copper powder (90%) previously sufficiently dispersed and an alumina powder was kneaded and dispersed under wet condition for 100 hours or more using a nonionic surfactant (Triton X-100, 1 wt %) as a dispersing medium.

The knead-dispersed material was filled in a die of a discharge plasma sintering apparatus, and sintered by discharge plasma at 700° C. to 900° C. for 5 minutes. In this procedure, the temperature raising rate was 250° C./min and a pressure of 10 MPa was loaded continuously. The electric conductivity of the resulting two composite materials was measured to find a value in a range of 500 to 800 W/mK in each case.

### Example 12

A stainless steel powder having an average particle size of 20 μm to 30 μm (SUS316L) and 0.5 wt % of long-chain carbon nanotubes were kneaded and dispersed by a planet mill using a stainless steel vessel under dry condition without using dispersion media, in combination of various time units of 2 hours or less and revolution number of the vessel.

Then, the knead-dispersed material was filled in a die of a discharge plasma sintering apparatus, and treated by discharge plasma at 575° C. for 5 minutes. Thereafter, the knead-dispersed material was sintered by discharge plasma at 900° C. for 10 minutes in a discharge plasma sintering apparatus. In this procedure, the temperature raising rate was 100° C./min and a pressure of 60 MPa was loaded continuously.

The heat conductivity of the resulting composite material was measured to find an increase of about 18% in the case of the composite material according to the present invention based on the heat conductivity of a solidified body obtained by sintering only a stainless steel powder by discharge plasma under the above-mentioned condition.

The electric resistance of the resulting composite material was measured to find an increase of about 60% (conductivity increased to about 1.65-fold) in the case of the composite material according to the present invention based on the electric resistance of a solidified body obtained by sintering only a stainless steel powder by discharge plasma under the above-mentioned condition.

### INDUSTRIAL APPLICABILITY

The carbon nanotube dispersed composite material according to the present invention can be used to produce electrode materials, exothermic bodies, wiring material, heat exchangers and fuel cells excellent in corrosion resistance and high temperature resistance, and the like, for example, using a ceramics powder. Heat exchangers, heat sinks, separators of fuel cells, and the like excellent in high heat conductivity can be produced using a metal powder such as a ceramics powder, aluminum alloy, stainless steel and the like.

1. A carbon nanotube dispersed composite material wherein long-chain carbon nanotubes are dispersed and integrated in the form of network into a discharge plasma sintered body comprising a ceramics (but excluding alumina) powder or a metal (but excluding aluminum or its alloy) powder.

2. A carbon nanotube dispersed composite material wherein long-chain carbon nanotubes are dispersed and integrated in the form of network into a discharge plasma sintered body composed of a mixed powder of ceramics and metal.

3. The carbon nanotube dispersed composite material according to claim 1, wherein the plasma sintered body comprises a ceramics powder and wherein the ceramics powder has an average particle size of 10 μm or less.

4. The carbon nanotube dispersed composite material according to claim 1, wherein the content of carbon nanotubes is 90 wt % or less by weight ratio.

5. The carbon nanotube dispersed composite material according to claim 1, wherein the discharge plasma sintered body comprises a ceramics powder and wherein the ceramics powder is comprises at least one material selected from the group consisting of alumina, zirconia, aluminum nitride, silicon carbide and silicon nitride.

6. The carbon nanotube dispersed composite material according to claim 1, wherein the discharge plasma sintered body comprises a metal powder, and wherein the metal powder comprises at least one metal compound selected from the group consisting of pure aluminum, aluminum alloy, titanium, copper, copper alloy and stainless steel.

7. A method of producing a carbon nanotube dispersed composite material comprising kneading and dispersing a ceramics (but excluding alumina) powder or metal (but excluding aluminum and its alloy) powder and long-chain carbon nanotubes in an amount of 10 wt % or less by a ball mill, and sintering the dispersed material by discharge plasma, thereby forming the carbon nanotube dispersed composite material.

8. A method of producing a carbon nanotube dispersed composite material comprising kneading and dispersing, by a ball mill, a ceramics (but excluding alumina) powder or metal (but excluding aluminum and its alloy) powder and long-chain carbon nanotubes in an amount of 10 wt % or less previously treated by discharge plasma, and sintering the dispersed material by discharge plasma, thereby forming the carbon nanotube dispersed composite material.

9. A method of producing a carbon nanotube dispersed composite material comprising kneading and dispersing a mixed powder of ceramics and metal and long-chain carbon nanotubes in an amount of 10 wt % or less by a ball mill, and sintering the dispersed material by discharge plasma, thereby forming the carbon nanotube dispersed composite material.

10. A method of producing a carbon nanotube dispersed composite material comprising kneading and dispersing, by a ball mill, a mixed powder of ceramics and metal and long-chain carbon nanotubes in an amount of 10 wt % or less previously treated by discharge plasma, and sintering the dispersed material by discharge plasma, thereby producing the carbon nanotube dispersed composite material.

11. A method of producing a carbon nanotube dispersed composite material comprising kneading and dispersing a ceramics (but excluding alumina) powder or metal (but excluding aluminum and its alloy) powder and long-chain carbon nanotubes by a ball mill, wet-dispersing said powder and carbon nanotubes using a dispersing agent, and sintering the dried knead-dispersed material by discharge plasma.

12. A method of producing a carbon nanotube dispersed composite material comprising kneading and dispersing, by a ball mill, a ceramics (but excluding alumina) powder or metal (but excluding aluminum and its alloy) powder and long-chain carbon nanotubes previously treated by discharge plasma, wet-dispersing said powder and carbon nanotubes using a dispersing agent, and sintering the dried knead-dispersed material by discharge plasma, thereby producing the carbon nanotube dispersed composite material.

13. A method of producing a carbon nanotube dispersed composite material comprising kneading and dispersing a mixed powder of ceramics and metal and long-chain carbon nanotubes by a ball mill, wet-dispersing said powder and carbon nanotubes using a dispersing agent, and sintering the dried knead-dispersed material by discharge plasma, thereby producing a carbon nanotube dispersed composite material.

14. A method of producing a carbon nanotube dispersed composite material comprising kneading and dispersing, by a ball mill, a mixed powder of ceramics and metal and long-chain carbon nanotubes previously treated by discharge plasma, wet-dispersing said powder and carbon nanotubes using a dispersing agent, and sintering the dried knead-dispersed material by discharge plasma.

15. The method of producing a carbon nanotube dispersed composite material according claim 7, wherein the sintering the dispersed material by discharge plasma comprises two steps of carrying out plasma discharge at low temperature under low pressure and then carrying out sintering by discharge plasma at low temperature under high pressure.

16. A heat exchanger comprising a carbon nanotube dispersed composite material comprising heat conductivity and high strength, wherein long-chain carbon nanotubes are dispersed and integrated in the form of a network into a discharge plasma sintered body comprising a ceramics (but excluding alumina) powder or metal (but excluding aluminum and its alloy) powder.

17. A heat exchanger comprising a carbon nanotube dispersed composite material comprising heat conductivity and high strength, wherein long-chain carbon nanotubes are dispersed and integrated in the form of a network into a discharge plasma sintered body comprising a mixed powder of ceramics and metal.

18. The carbon nanotube dispersed composite material according to claim 2, wherein the metal powder, of the mixed powder, has an average particle size of 200 μm or less.

19. The carbon nanotube dispersed composite material according to claim 2, wherein the ceramics powder, of the mixed powder, has an average particle size of 10 μm or less.

20. The carbon nanotube dispersed composite material according to claim 2, wherein the content of carbon nanotubes is 90 wt % or less by weight ratio.
